(19) United States
(12) Patent Application Publication
(10) Pub. No.: US 2003/0029223 A1
(43) Pub. Date: Feb. 13, 2003

(54) Fully automated, self testing level sensor

(76) Inventors: J. Lawrence Taylor III, Katy, TX (US); Paul R. Bennett JR., Houston, TX (US)

Correspondence Address: Browning Bushman P.C., Suite 1800, 5718 Westheimer, Houston, TX, 77057, US

(21) Appl. No.: 10/216,423

(22) Filed: Aug. 9, 2002

Related U.S. Application Data
(60) Provisional application No. 60/311,090, filed on Aug. 10, 2001.

(51) Int. Cl. G01S 7/40

(52) U.S. Cl. 73/1.73; 73/1.01

(57) ABSTRACT

A system and a method of automatically and periodically checking the integrity of a mechanical level sensor system for a storage tank are provided. These mechanical sensors employ a magnetic mechanism to lift the displacers or floats to the full travel of the level sensor in order to simulate a level alarm condition. A timer and activation module periodically energizes the magnetic lift mechanism. An array of indicators and logic provides an indication to the operator of normal operation, a satisfactory test, an unsatisfactory test, and a genuine alarm condition.

This application claims priority from Provisional U.S. Patent Application Ser. No. 60/311,090 filed Aug. 10, 2001.

### FIELD OF THE INVENTION

The present invention relates generally to the field of level sensors for storage tanks, and, more particularly, to a fully automated test feature for such a level sensor.

Many State and local ordinances now require redundant overfill protection on most large liquid storage vessels. Also, the United States Environmental Protection Agency has proposed new legislation (Spill Prevention, Control and Countermeasures (SPCC) regulation (40 CFR Part 112)), which will mandate overfill protection on most large storage vessels.

Compliance with these requirements can be extremely costly, because of the expense of installing electrical wiring and conduits to power the level sensors and convey alarm signals back to a central control point. In U.S. Pat. No. 6,229,448, we described a cost-effective alternative to electrical wiring and conduit for power and control signals, and this patent is incorporated herein by reference. The system shown, described, and claimed in our '448 patent is an intrinsically-safe approved, battery-powered, radio transmitter used to transmit alarm signals from hazardous areas to safe areas. Its internal battery can also power level switch circuits for several years, thus eliminating the need for electrical service at the vessels being monitored.

This ability to provide overfill protection without the expense of installing electrical service at a vessel does limit the selection of level sensors. Because the system shown in the '448 patent is completely battery-powered, it must employ level sensors that require little or no electrical power in order to be long-lived. This generally requires the application of mechanical sensors such as float or displacer switches. Because these types of sensors come into contact with the various fluids in the vessels, they tend to be more prone to fouling than non-contact sensors, such as capacitive or acoustical sensors.

One significant requirement of virtually all existing and proposed regulations is routine, periodic testing of the overfill instrumentation. This means that the level-sensing device must be equipped with some method of simulating a level alarm condition and initiating the alarm annunciation sequence to verify the entire system is functioning properly. This process usually involves having an operator manually activate the level sensor testing mechanism at each vessel on a weekly or monthly interval. With the mechanical level switches typically used with previously described systems, this necessitates physically moving the floats or displacers to a point where an alarm condition is triggered. In fact, in U.S. Pat. No. 4,142,079, Bachman taught using a magnetic coupling to lift a float in this type of situation.

Many facilities have hundreds of storage tank and other types of vessels, and thus manual routine testing of their overfill protection systems is extremely labor-intensive and costly. The present invention addresses this drawback in the art by providing a completely self-contained and automatic method and system for testing the overfill protection system.

### SUMMARY OF THE INVENTION

The present invention provides a system and a method of checking the integrity of a mechanical level sensor system, such as those provided by National Magnetic Sensors, Inc., for example. These mechanical sensors employ a magnetic mechanism to lift the displacers or floats magnetically the full travel of the level sensor in order to simulate a level alarm condition. However, the present invention provides a timer and activation module which periodically energizes the magnetic lift mechanism. An array of indicators and logic provides an indication to the operator of normal operation, a satisfactory test, an unsatisfactory test, and a genuine alarm condition.

The magnetic lift test structure includes a knob on top of the sensors, and the knob is attached to a rod with a magnet on the bottom end. The float or displacer includes two magnets; the top magnet is for the testing mechanism, and the bottom magnet activates a reed switch. When the knob on the top of these level sensors is lifted, the floats or displacers are magnetically lifted through a stainless steel float shaft, but only if the moving parts (i.e., the floats and shafts) are not fouled. Since there is only sufficient magnetic force to lift the floats when the shaft and floats are clean, the magnets will separate if either is fouled.

The present invention provides a device and methodology for performing the required periodic testing of the overfill protection system without the need for labor-intensive human intervention. This device and its related methodology can be applied to virtually any mechanical level switch, which preferably provides a magnetically-coupled lifting mechanism, which is considered to be a very desirable feature.

This invention comprises a linear electric actuator coupled with a battery and an electronic timer circuit. The timer circuit, powered by the battery, is programmed to periodically activate the linear actuator, thus testing the level sensor to which it is attached. The timer can be programmed to activate the actuator at virtually any desired interval, such as daily, weekly, or monthly. It can be deployed either as a “hard-wired” device, or coupled with a battery-powered radio telemetry device such as that shown and described in the '448 patent. When used with the radio telemetry system, the entire system becomes “stand-alone”; that is, no wiring is needed at the vessel.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is an elevation view of a first preferred embodiment of a hard wired level sensor test system of this invention.

FIG. 2 is an elevation view of another preferred embodiment of a wireless level sensor test system of the invention.

FIG. 3a is an elevation view of a lift system portion of the invention, shown in normal mode.

FIG. 3b is an elevation view of a lift system portion of the invention illustrating a normal test.

FIG. 3c is an elevation view of a lift system portion of the invention illustrating a failed test.

FIG. 4 is a logic circuit illustrating the operation of the various states of the system.

FIG. 5 is an elevation schematic view of the self test system of this invention with further details of the battery and timer features of the invention.

### DETAILED DESCRIPTION OF A PREFERRED EMBODIMENT

FIG. 1 illustrates a fully automated level sensor test system 10 constructed in accordance with a first preferred embodiment of the invention. The system 10 is mounted to the top of a storage tank 12 so that a level of fluid 14 within the tank can be monitored. If the level in the tank rises too high, it lifts a float 16, thereby initiating an alarm and alerting personnel to the condition. However, such a float 16 may become fouled, and thus the purpose of the present invention is to periodically test the proper functioning of the level alarm system without any human intervention. It should be noted that although a single set point float is illustrated in the following description, other types of mechanical level sensors are equally applicable to the present invention, such as for example displacer switches for internal floating roof tanks, dual set point float switches, and the like.

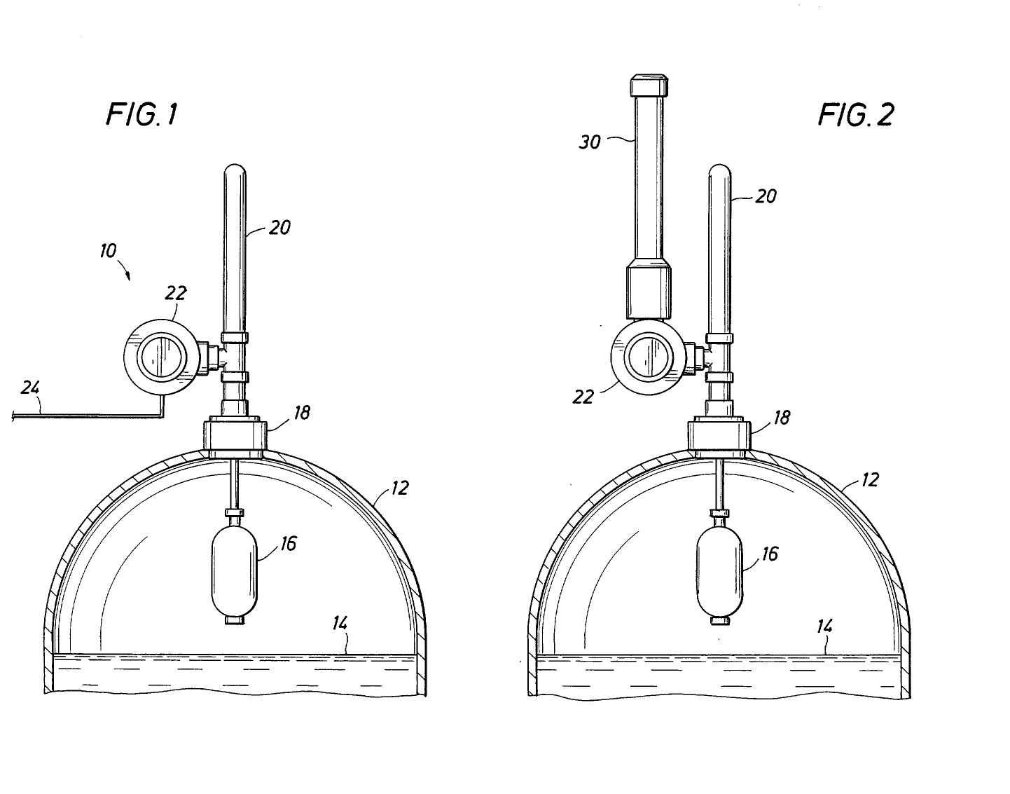

The system 10 is mounted to the tank 12 with a sealed mount 18. The mount 18 supports an electric linear actuator section 20, which is used to pull the float 16 up for test of the proper functioning of the float. The actuator section is a solenoid device which, when energized, lifts an internally mounted rod, described below, to lift the float. The actuator section is periodically energized a timer and battery section 22 mounted to the side and also supported by the mount. The condition of the system, whether normal operation, alarm condition, successful test, or failed test, is provided to a remote station (not shown) over an electrical conduit 24. However, stringing such an electrical conduit is often inconvenient or too expensive, and thus the wireless embodiment shown in FIG. 2 is provided.

The system shown in FIG. 2 includes the same installed components, except that the electrical conduit for the conduction of alarm relays and test status relay outputs is replaced by a transmitter 30, constructed in accordance with the teachings of our U.S. Pat. No. 6,229,448. The transmitter 30 is intrinsically safe, battery powered, and suitable for all appropriate environments to which the present invention is adapted. The transmitter sends the alarm relays and test status relay outputs to the remote station (not shown), and is powered from the timer and battery section 22.

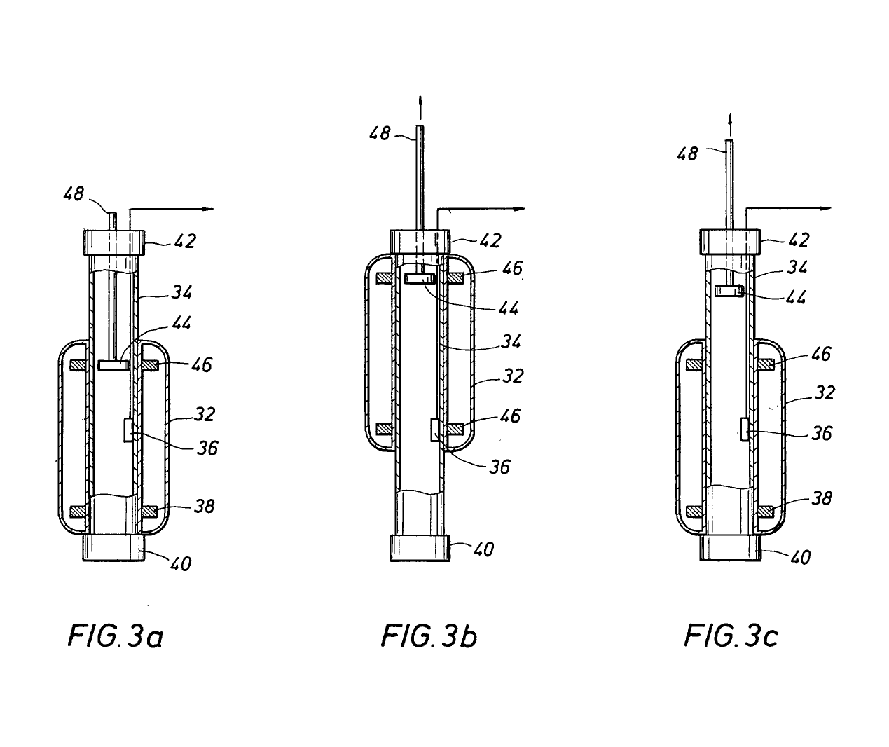

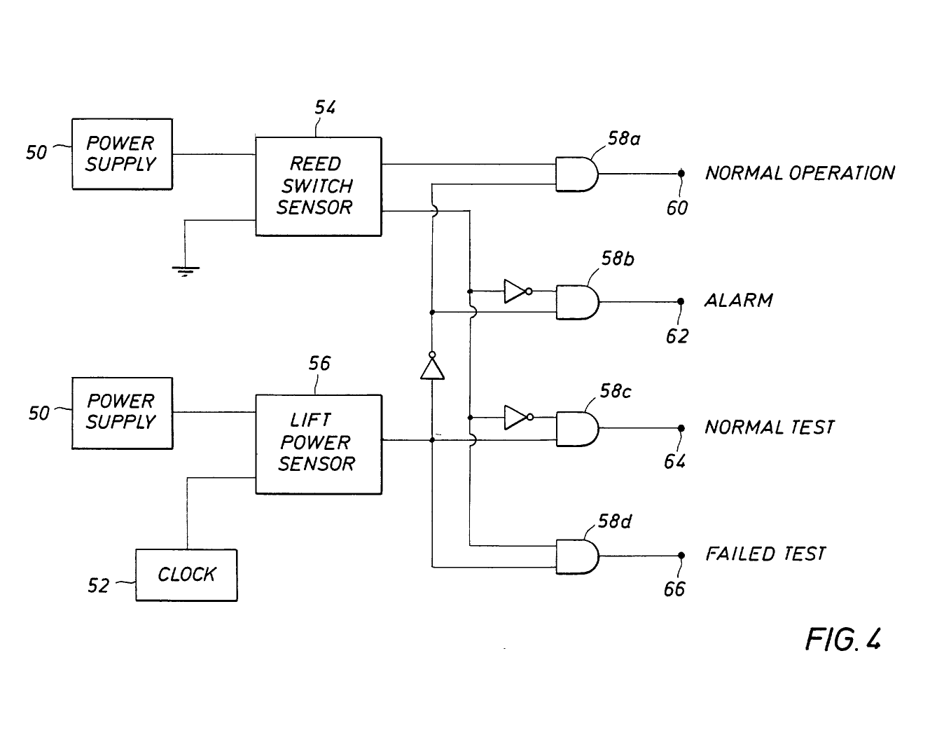

FIGS. 3a, 3b, and 3c illustrate the operation of a typical float during various phases of operation. The float comprises primarily a stainless steel float 16 which during normal operation slides up and down on a hollow stainless float shaft 34. Mounted on the inside of the shaft is a reed switch 36, whose job it is to sense the absence or presence of a reed switch magnet 38 mounted to the inside of the float 16. When the float 16 is all the way down against a bottom float stop 40, then the reed switch is open and does not conduct. When the float moves up, the reed switch magnet 38 moves up with it, and when the float reaches the full up position against a top float stop 42, then the reed switch magnet 38 is in proximity to the reed switch. The reed switch shuts and conducts, the effect of which is explained below in respect of FIG. 4.

Also mounted to and within the float 16 is a lifting magnet 44 in the form of a circular disk. A toroidal sense magnet 46 surrounds the lift magnet 44, creating a magnetic flux therebetween. Further, mounted to the top of the lifting magnetic 44 is a rod 48. During normal operation (i.e. non-test conditions) the magnets 44 and 46 maintain their flux coupling, and the rod moves up with the float. If the level in the tank rises too high, then the reed switch shuts, thereby conducting, and an alarm is sounded. FIG. 3b illustrates the positions of the various components during a normal test operation. In this case, the rod 48 is lifted by the linear actuator 20, thereby simulating a rising level in the tank. So long as the float 16 does not hang up on the float shaft 34, the magnets 44 and 46 retain their flux coupling, and the magnets remain together. Further, the reed switch shuts, and signals to the remote station the result of a successful test.

However, FIG. 3c illustrates what happens if the float fails to rise when the rod is pulled up by the linear actuator. The reed switch is not actuated, and the magnets 44 and 46 become separated by losing the flux coupling. This condition alerts the remote station of a failed test.

These various conditions are illustrated in FIG. 4. The logic circuit of FIG. 4 comprises a power supply 50 and a clock or timer 52, and the logic to determine the status of the system 10. The logic includes a reed switch sensor 54, to detect if the reed switch is open or shut, and a lift power sensor 56, which senses when the clock 52 periodically provides power to the linear actuator to lift the rod, thereby simulating an overfill condition. The sensors 54 and 56 feed signals to a series of AND gates 58a through 58d, respectively. During normal operation, the reed switch is open, feeding a high signal to the AND gate 58a. The lift power sensor is not activated, so an inverter signal feeds the AND gate 58a, developing a signal at a normal operation indicator 60. This signal is either constantly or, more preferably, periodically transmitted to the remote station to verify proper operation of the system, and thereby save on battery life.

If the reed switch sensor determines that the reed switch is shut, meaning the float has reached the top stop, then the AND gate 58a receives a low signal from the reed switch sensor and the indicator 60 goes off. Simultaneously, the AND gate 58b receives an inverted signal from the reed switch sensor 54, and since there is no power being applied to the linear actuator, no signal is being sent by the lift power sensor 56, an alarm indicator 62 is actuated. However, if power is being applied to the linear actuator, then the lift power sensor sends a signal, and the inverted sensor signal turns off, and the alarm indicator 62 is not actuated. In this case, an uninverted signal is sent to the AND gate 58c, which also receives a signal from the reed switch sensor 54, and a normal test indicator 64 is actuated. Finally, if the lift power sensor 56 sends a signal, but the reed switch fails to shut, then the AND gate 58d receives two signals at its input, and a failed test indicator 66 is actuated.

In the scenario just described, the timer and battery section 22 is set at a user selectable interval to provide power to the linear actuator 20 in an attempt to lift the rod 48. If the magnets 44 and 46 maintain their flux coupling, then the float is lifted, and a normal test is indicated by the indicator 64. If the float is fouled, or otherwise fails to lift, then the rod rises but the float does not. In this case, the reed switch fails to shut, and the indicator 66 is actuated.

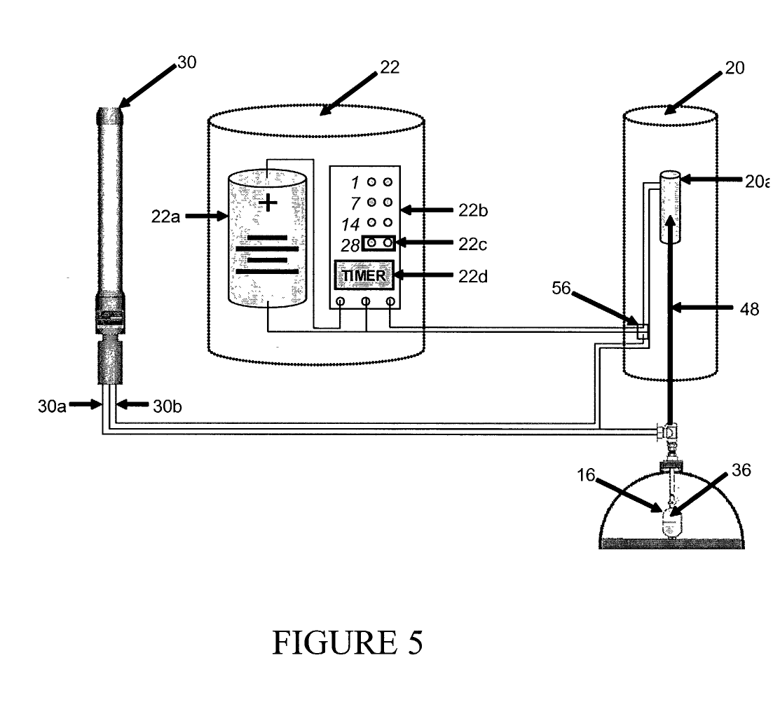

FIG. 5 shows an overfill prevention system employing a wireless transmitter 30 and coupled to the automatic testing system of the present invention. A suitable battery 22a, which may be a D-Cell lithium ion cell, and test activation timer module 22b are housed in the timer/battery enclosure 22, which may be explosion-proof in construction. The test activation timer module 22b includes a battery-conserving solid-state timer circuit 22d which controls the system test interval. The battery 22a is used to power the test activation timer module 22b and an electric test actuator 20a. The test activation timer module 22b provides the user with the capability to select the system test interval. In the example shown, the test activation timer module includes a user-selectable 4-position jumper switch 22c which permits the user to select a daily, 7 day, 14 day, or 28 day system test interval. In the example shown, a 28 day (monthly) system test interval has been selected.

During an actual overfill situation, the fluid level 14 in the storage tank 12 rises to a point that the buoyant float 16 moves upward sufficiently that the reed switch magnet 38 inside the float is positioned adjacent the reed switch 36 inside the float shaft 34. When this occurs, the reed switch 36 closes (or opens as desired by design). Because the reed switch 36 is connected to the Alarm A input 30a of the transmitter 30, an alarm signal is transmitted from the transmitter to a receiver (not shown), and an overfill is averted.

When a system test is initiated by the test activation timer module 22b, power is applied to the electric test actuator 20a, and the rod 48 is lifted. The rod has a lifting magnet 44 on its lower end which interacts with the magnet 46 inside the float 16. Because the float shaft 34 and float 16 are constructed using non-ferrous materials such as stainless steel or plastic, the float 16 will be lifted when the rod 48 is lifted, providing the entire mechanism is clean and the float 16 is unencumbered.

During a successful system test (FIG. 3b), the lift power sensor 56 (FIGS. 4 and 5) is activated when power is applied to the electric test actuator 20a. Because the lift power sensor 56 is connected to the Alarm B input 30b of the transmitter 30, the system is notified that a test is being conducted rather than an actual overfill situation. Providing the float 16 is in good operating condition, it will move upward when its internal magnet 46 is attracted by the lifting magnet 44. When this occurs, the reed switch magnet 38 will end up adjacent to the reed switch 36, which is connected to the Alarm A input 30a of the transmitter 30. When a successful test is conducted, the transmitter 30 transmits both an Alarm A signal float reed switch and an Alarm B signal lift power sensor.

During a failed test (FIG. 3c) the float is unable to move upward when the test is initiated and the magnet 46 inside the float 16 and the lifting magnet 44 on the end of the rod 48 will separate. In this situation, the transmitter 30 will only transmit an Alarm B signal lift power sensor. Another “failed test” condition could be annunciated if the Receiver failed to receive an Alarm B signal lift power sensor when a system test was scheduled to occur.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. A system for testing the integrity of a float sensor in a storage tank, the system comprising:
a. a float adapted to detect a high level condition in the storage tank;
b. an actuator, releasably coupled to the float, to move the float, thereby simulating a high level condition in the tank;
c. a timer to periodically and automatically energize the actuator; and
d. logic to determine if the actuator is released from the float when the actuator is energized.

2. The system of claim 1, wherein the periodicity of the energizing of the timer is selectable by a user.

3. The system of claim 1, wherein the logic to determine if the actuator is released from the float defines an alarm logic.

4. The system of claim 1, wherein the alarm logic provides an indication of a malfunction in the float sensor.

5. The system of claim 4, wherein the alarm logic further provides an indication of an overfill condition in the storage tank.

6. A method of testing the integrity of a float sensor in a storage tank, comprising the steps of:
mounting a float within the storage tank, the float coupled to a lifting rod by a magnetic coupling;
attempting to lift the float by periodic actuation of an automated timer; and
if the float fails to lift due to a break in the magnetic coupling between the lifting rod and the float, transmitting an alarm.
